(19) United States
(12) Patent Application Publication
(10) Pub. No.: US 2013/0035042 A1
(43) Pub. Date: Feb. 7, 2013

(54) WIRELESS COMMUNICATION SYSTEM AND MANUFACTURING METHOD OF SAME

(71) Applicants: Munenori Matsumoto, Kariya-city (JP); Akira Takaoka, Okazaki-city (JP); Tohru Yamaguchi, Anjo-city (JP)

(72) Inventors: Munenori Matsumoto, Kariya-city (JP); Akira Takaoka, Okazaki-city (JP); Tohru Yamaguchi, Anjo-city (JP)

(73) Assignee: DENSO CORPORATION, Kariya-city (JP)

(21) Appl. No.: 13/562,701

(22) Filed: Jul. 31, 2012

(30) Foreign Application Priority Data
Aug. 2, 2011 (JP) 2011-169367

(51) Int. Cl. H04W 88/02

(52) U.S. Cl. 455/66.1

(57) ABSTRACT

A wireless communication system has an in-vehicle system disposed in a vehicle and a portable device carried by a user, where the in-vehicle system and the portable device are communicably coupled. The in-vehicle system uses a transmitter for transmitting a request signal to the portable device in LF wave band, and the transmitter includes: a spread process unit for spread-modulating predetermined LF data by a spread spectrum method and for generating a spread data signal; and a modulation driver unit for converting the spread data signal to a modulation signal in the LF wave band and for outputting such modulation signal as a request signal to an antenna after amplifying the modulation signal.

### CROSS REFERENCE TO RELATED APPLICATION

The present application is based on and claims the benefit of priority of Japanese Patent Application No. 2011-169367, filed on Aug. 2, 2011, the disclosure of which is incorporated herein by reference.

### TECHNICAL FIELD

The present disclosure generally relates to a wireless communication system and a manufacturing/implementing method of an in-vehicle system by using such wireless communication system.

### BACKGROUND

Conventionally, a wireless communication system including an in-vehicle system installed in a vehicle and a portable device carried by a user communicating bi-directionally with each other may have been considered as a smart system, in which the in-vehicle system transmits a vehicle-side request signal by using a low frequency (LF) wave band to the portable device in a “near-vehicle” communication area, and the portable device in response returns a portable-side signal, for an operation of an in-vehicle actuator such as a door lock device, a door lock releaser, or a lamp device. Such a system is disclosed in, for example, Japanese Patent Laid-Open No. 2000-104429 (JP '429) and Japanese Patent Laid-Open No. 2010-001642 (JP '642).

In the technology of such a smart system, a need to expand the coverage area of the vehicle-side request signal has been recognized. For expanding the coverage area of the vehicle-side request signal, an LF output may be increased on the in-vehicle system side. However, simply increasing the LF output may lead to the increased intensity of the request signal. Therefore, in a situation where the signal intensity (i.e., a radio field intensity) of the request signal may not be increased (e.g., due to a Japanese Radio Law regulation prohibiting a signal intensity exceeding a certain maximum value), such method may not be used.

Further, increasing the reception sensitivity on the portable device side may be an option to expand the coverage area of the request signal. However, such method may also be problematic, since the increase of the reception sensitivity may lead to deteriorated noise tolerance.

### SUMMARY

In an aspect of the present disclosure, the wireless communication system includes an in-vehicle system installed in a vehicle and a portable device carried by a user, where the in-vehicle system and the portable device are communicably coupled. The in-vehicle system has a transmission unit for transmitting a request signal in a low frequency (LF) wave band to the portable device, and the portable device transmits a response signal upon receiving the request signal. The in-vehicle system has a smart operation unit for operating an actuator in the vehicle based on the response signal received from the portable device. The transmission unit includes a spread process unit for spread-modulating predetermined LF data by using a spread spectrum method to generate a spread data signal, and a modulation driver unit for converting and amplifying the spread data signal to a modulation signal and for transmitting the modulation signal to an antenna as the request signal.

In the in-vehicle system of the wireless communication system, since the signal of LF data is spread into a wide frequency band by spread-modulation in a spread spectrum method, the peak level of the output power of the signal is lowered, in comparison to the non-spread-modulated signal of the LF data. Therefore, the signal amplification rate can be increased in comparison to the non-spread-modulated signal of LF data. As a result, the request signal has an expanded coverage while keeping the radio wave (i.e., signal) intensity within an intended range, and without losing the noise tolerance.

Further, in the wireless communication system, a maximum signal intensity output from the antenna is smaller than 105 dBuV/m, which is made smaller than 105 dBuV/m by not bypassing the spread process unit. That is, in other words, the maximum signal intensity output from the antenna can be, or becomes, greater than 105 dBuV/m if the predetermined LF data is directly inputted to the modulation driver unit by bypassing the spread process unit. In such manner, without violating regulations, such as the Radio Wave Law in Japan, the communicable range is expanded.

Further, in addition to the above wireless communication system, an amplification rate of the modulation driver unit is increased according to an increase of the spread rate of the spread process unit. In such manner the communicable range is properly expanded by setting the amplification rate according to the spread rate.

Further, the present disclosure may be a method for manufacturing the in-vehicle system of the wireless communication system, where the in-vehicle system has an in-vehicle apparatus disposed in a vehicle, and the in-vehicle apparatus and the portable device are communicably coupled. The manufacturing method includes installing, in the in-vehicle apparatus, the transmission unit, where the transmission unit includes the spread process unit and the modulation driver unit, and installing the smart operation unit for operating the actuator in the vehicle. In addition, setting the amplification rate of the modulation driver unit according to the spread rate of the spread process unit. By setting the amplification rate according to the spread rate, the communicable range is properly expanded according to the spread rate.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of a smart system of the present disclosure;

FIG. 2 is a block diagram of an LF transmitter and an LF receiver of the smart system of FIG. 1;

FIG. 3 is a flowchart of a process performed by a vehicle-side controller of the smart system;

FIG. 4 is a flowchart of a process performed by a control unit of a portable device of the smart system;

FIGS. 5A, 5B, 5C, 5D are diagrams of a signal power level of transmitted signals from an LF transmission antenna; and

FIG. 6 is a diagram of a signal intensity of a signal transmitted from the LF transmission antenna.

### DETAILED DESCRIPTION

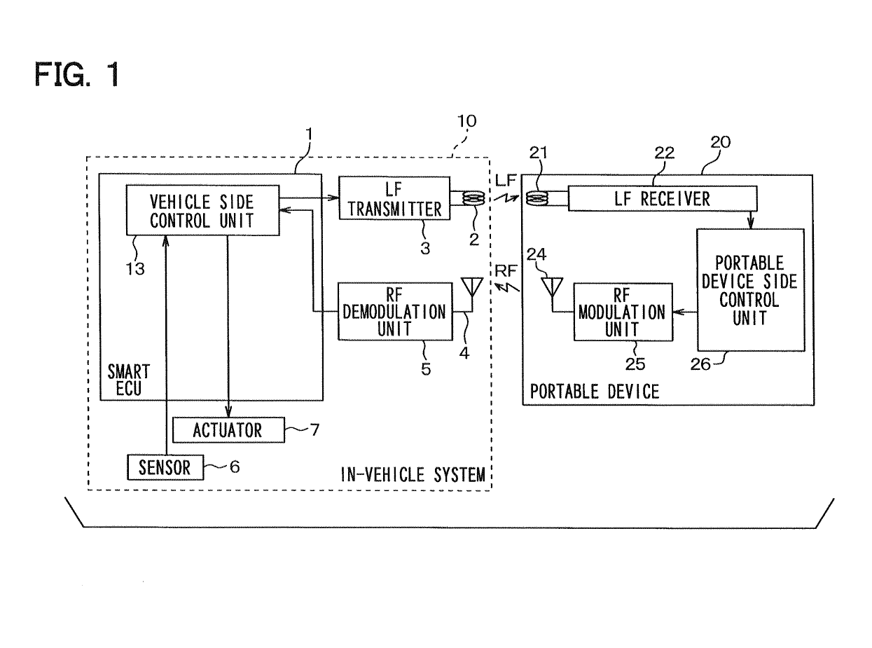

An embodiment of the present disclosure is described in the following. FIG. 1 shows a block diagram of a smart system in an embodiment of the present disclosure, which is a wireless communication system. The smart system performs, as its featured operation (i.e., a “smart operation”) of vehicular devices, a welcome control, such as a “welcome lighting” that turns on a welcome light of a vehicle, such as a dome light, when the doors are unlocked, as well as unlocking of the vehicle doors and starting a vehicle driving unit (e.g., an engine). The smart system includes an in-vehicle system 10 installed in a vehicle and a portable device 20 that is carried by a user.

In the present system, a request signal in low frequency (LF) wave band is transmitted from the in-vehicle system 10 to the portable device 20, and a response signal in radio frequency (RF) wave band is transmitted from the portable device 20 back to the in-vehicle system 10. LF wave band and RF wave band may simply be referred to as LF band and RF band, respectively

The LF band communication distance is described in detail. Though communication in the RF band is performed, due to the use of a short wavelength, in a radiation (electro-magnetic) field even for a short range communication, the wireless communication in LF band is performed, due to the use of a long wavelength for its communication distance, in an induction (electro-magnetic) field. While the attenuation in distance in RF band is in reverse proportion to the square of the distance, the attenuation in distance in LF band is in reverse proportion to the cube of the distance. Therefore, the communication in LF band can be an area specific communication that strictly limits the communication range to a certain area size.

The in-vehicle system 10 has a smart ECU 1, an LF transmission antenna 2, an LF transmitter 3, an RF reception antenna 4, an RF demodulation unit 5, a sensor 6, and an actuator 7.

The LF transmission antenna 2 is an antenna for wirelessly transmitting a signal (i.e., an LF radio wave) in LF wave band. The LF transmitter 3 outputs an LF data signal from the smart ECU 1 to the LF transmission antenna 2 by modulating the signal in the LF wave band. The modulation method for modulating the signal may be a spread spectrum (modulation) method.

The spread spectrum (modulation) method is described here in detail. The spread spectrum modulation method spreads the signal into a wide frequency range by multiplying the data signal with a spread code (i.e., spread process), and demodulates the data signal by multiplying the same spread code at the same timing (i.e., reverse spread processing, or de-spreading) at the time of receiving the signal.

In the present embodiment, the signal from the in-vehicle system 10 to the portable device 20 is spread to the wide frequency range, for decreasing the peak level of the signal output and for supplementing the signal intensity of transmission output, thereby effecting the expansion of the communication range.

The RF reception antenna 4 is an antenna for wirelessly receiving an RF signal (i.e., an RF radio wave) in the RF wave band. The RF demodulation unit 5 demodulates the signal in the RF wave band received by the RF reception antenna 4, and outputs the demodulated signal to the smart ECU 1 as the signal of RF data.

The sensor 6 is installed on a door handle part of the door of the vehicle, and detects the user operation for opening the door or for grabbing the door handle, and outputs such detection result to the smart ECU 1. The sensor 6 may be implemented as, for example, a touch sensor.

The actuator 7 is a device that is one of target devices/mechanisms of the smart operation, and may include a device and a mechanism, such as a welcome light and its switching mechanism in the vehicle, a starter motor for starting an engine of the vehicle (or, an engine ECU which controls the starter motor), or a door lock mechanism for locking/unlocking the door of the vehicle (or, a door ECU which controls the door lock mechanism).

The smart ECU 1 is an electric control unit, which performs the smart operation based on communication with the portable device 20 by exchanging signals with the LF transmission unit 3, the RF demodulation unit 5, the sensor 6, and the actuator 7. The smart ECU 1 includes a vehicle side control unit 13.

The vehicle side control unit 13 is implemented as a microcomputer which includes a CPU, a RAM, a ROM, an input/output and realizes a process of various kinds under control of the CPU that executes a program recorded in the ROM, using the RAM as a work area. In the following, the process performed by the CPU is described as a process performed by the vehicle side control unit 13.

The portable device 20 has an LF reception antenna 21, an LF receiver 22, an RF transmission antenna 24, an RF modulation unit 25, and a portable device side control unit 26.

The LF reception antenna 21 is an antenna for receiving a signal in the LF wave band transmitted from the in-vehicle system 10. The LF receiver 22 demodulates the signal in the LF wave band, which is received by the LF reception antenna 21, and outputs the demodulated signal as a signal of LF data to the portable device side control unit 26. The demodulation of the signal may be performed by a spread spectrum modulation method.

The RF transmission antenna 24 is an antenna for wirelessly transmitting the signal in the RF wave band (i.e., an RF radio wave). The RF modulation unit 25 modulates a signal of RF data output from the portable device side control unit 26, and provides the modulated signal in the RF wave band to the RF transmission antenna 24.

The portable device side control unit 26 is implemented as a microcomputer, which includes a CPU, a RAM, a ROM, an input/output and realizes a process of various kinds under control of the CPU that executes a program recorded in the ROM, using the RAM as a work area. In the following, the process performed by the CPU is described as a process performed by the vehicle side control unit 26.

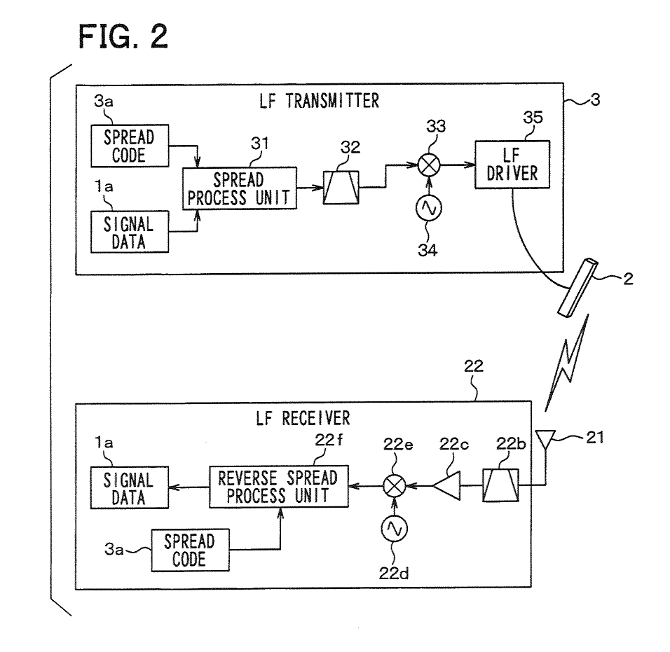

The LF transmitter 3 of the in-vehicle system 10 and the LF receiver 22 of the portable device 20 are described in detail. FIG. 2 shows the configuration of the LF transmitter 3 and the configuration of the LF receiver 22.

The LF transmitter 3 has a spread process unit 31, a band pass filter 32, a primary modulation unit 33, a carrier output unit 34, and an LF driver 35. The spread process unit 31 performs a spread modulation by the spread spectrum modulation method by using a spread code 3a that is pre-recorded in a storage medium for a data signal 1a (i.e., the LF data), which is provided by the vehicle side control unit 13. The spread process unit 31 provides the spread-modulated signal (i.e., a spread data signal) to the band pass filter 32. The band pass filter 32 extracts only signal components in a predetermined wave band from among the spread-modulated signal, and provides the extracted signal to the primary modulation unit 33.

The primary modulation unit 33 performs a primary modulation of the spread-modulated signal that is provided by the band pass filter 32 by using an LF carrier signal (i.e., a sine wave signal of 134 kHz) from the carrier output unit 34. The modulation method may be, for example, a phase-shift keying (PSK) method. The signal after the primary modulation in the primary modulation unit 33 is provided to the LF driver 35 as a signal in the LF wave band.

The LF driver 35 amplifies the signal in the input LF wave band at the predetermined amplification rate, and provides the amplified input signal in the LF wave band to the LF transmission antenna 2. In this manner, the signal in the LF wave band is transmitted as a request signal from the LF transmission antenna 2.

Further, the LF receiver 22 has a band pass filter 22b, an amplifier 22c, a carrier output unit 22d, a primary demodulation unit 22e, and a reverse spread process unit 22f. When the LF reception antenna 21 receives the signal in the LF wave band (i.e., the signal in the LF wave band transmitted from the in-vehicle system 10), the band pass filter 22b extracts only the signal components in a predetermined wave band, and inputs the extracted signals to the amplifier 22c. The amplifier 22c amplifies the input signal, and inputs the amplified signal to the primary demodulation unit 22e.

The primary demodulation unit 22e performs a primary demodulation of the signal provided by the amplifier 22c by using the LF carrier signal (i.e., a sine wave signal of 134 kHz) from the carrier output unit 22d. The signal after the primary demodulation in the primary demodulation unit 22e is provided to the reverse spread process unit 22f. The demodulation method may be the same as the method used in the primary modulation unit 33, for example, a PSK method.

The reverse spread process unit 22f performs a reverse spread demodulation by using a spread code 3a that is pre-recorded in a storage medium for a data signal 1a, where the spread code 3a is the same code used by the spread process unit 31. The primary demodulation unit 22e provides the signal after the primary demodulation to the reverse spread process unit 22f, and the reverse spread process unit 22f outputs the data signal 1a as a result of the reverse spread demodulation (i.e., the LF data) to the portable device side control unit 26. The data signal 1a becomes the same data as the data signal 1a that is spread-modulated in the LF transmitter 3. Further, a synchro-capture process, which is required for the reverse spread demodulation, is also performed by this reverse spread process unit 22f.

The operation of the smart system having the above-described configuration is described in the following.

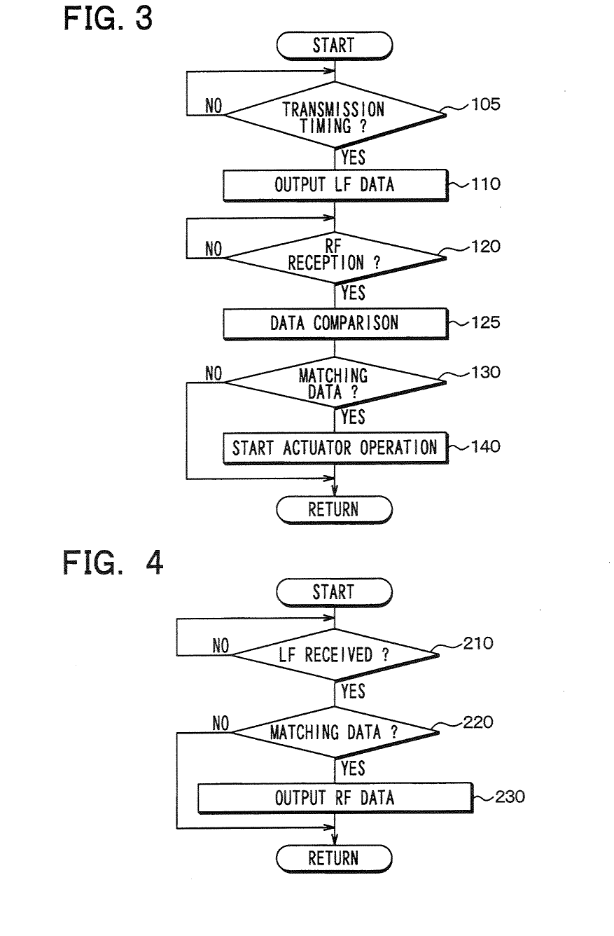

FIG. 3 is a flowchart of a process that is performed by the vehicle side control unit 13 in the smart ECU 1, and FIG. 4 is a flowchart that is performed by the portable device side control unit 26 in the portable device 20.

First, in step 105, the vehicle side control unit 13 waits for a transmission timing. The transmission timing may be, for example, a polling timing which happens regularly at every ¼ second periods, or a sensor detected user operation timing of opening the door (i.e., grabbing the door handle), which is detected by the sensor 6.

When the transmission timing comes, the process proceeds to step 110 to generate a predetermined LF data, and outputs the data to the LF modulation unit 3. The LF transmitter 3 spread-modulates and primary-modulates the LF data. After being modulated, the LF data is wirelessly transmitted from the LF transmission antenna 2 as a request signal, which is mainly provided as a signal in the LF wave band. Subsequently, in step 120, the process waits for the reception of the signal in the RF band.

With reference to FIG. 4, than the portable device 20 in a signal wait state determines, in step 210, whether the portable device side control unit 26 has received the LF data signal, and the process proceeds to step 220. The data received in step 210 is the LF data as a result of the primary demodulation and the reverse spread demodulation of the request signal received by the LF receiver 22.

In step 220, the process determines whether the LF data included in the request signal received (i.e., the signal mainly in the LF wave band: a central frequency of the signal is in the LF wave band) is a proper signal, by using a well-known method, such as matching the data with a proper data. Since the portable device 20 is compatible with the in-vehicle system 10, the LF data in the transmitted signal transmitted from the in-vehicle system 10 in the LF wave band is determined as proper, and the process proceeds to step 230. However, if the data is not a proper one, the process returns to 210.

In step 230, the process generates predetermined RF data, and outputs the RF data to the RF modulation unit 25, where the RF data is modulated. The RF data modulated by the RF modulation unit 25 is wirelessly transmitted as the signal in the RF wave band from the RF transmission antenna 24. The signal in the RF wave band has an extended reach in comparison to the signal in the LE wave band. After step 230, the process returns to step 210.

When the signal in the RF wave band including the RF data is transmitted as described above, the RF reception antenna 4 of the in-vehicle system 10 receives the signal in the RF wave band, and the RF demodulation unit 5 outputs the signal of the RF data after demodulating the signal in the RF wave band to the vehicle side control unit 13.

With reference to FIG. 3, in step 120, the vehicle side control unit 13 determines whether it has received the RF data, and the process proceeds to step 125. In step 125, the received RF data is compared with a predetermined reference data for determining whether the received data is a proper data.

In step 130, the process determines whether the RF data is a proper one by using a well-known method based on the result of comparison in step 125 (e.g., whether or not the received RF data matches with the reference data).

Because the portable device 20 which has transmitted the signal in the RF wave band including the RF data is compatible with the in-vehicle system 10, the RF data is determined as a proper one, and the process then proceeds to step 140.

In case that the received signal in the RF wave band is not the signal from the portable device 20, the process determines in step 130 that the received RF data is not a proper one, and the process skips step 140 to return to step 105. In such manner, the smart operation is prohibited.

In step 140, the smart operation is started. More practically, by controlling the actuator 7, the welcome control or the like is performed. The welcome control may be, for example, turning on the welcome light of the vehicle via the actuator 7, in order to light an area in proximity to a door of the vehicle. Further, after turning on the welcome light, the area illuminated by the welcome light may be changed by controlling the light axis of the welcome light, so that the lamp-lighted area approaches the vehicle from a position that is, for example, 2 to 3 meters away from the vehicle. Further, the smart operation is in a stand-by state until detecting the next event, such as a touch on the door by the driver or an engine start operation for starting the engine. In this case, a driver's touch on the door may unlock the door, and the engine start operation may start the engine.

The signal intensity of the signal in the LF wave band transmitted from the in-vehicle system 10 is described in the following. In the present embodiment, the LF transmitter 3, as described above, spread-modulates the LF data (i.e., the data signal 1a) to generate the spread data signal by using the predetermined spread code 3a in the spread process unit 31 and the band pass filter 32. The LF transmitter 3 then converts the spread data signal to the modulation signal in the LF wave band via the primary modulation unit 33, and amplifies the modulation signal in LF driver 35 to output the amplified signal to the antenna 2 as a request signal.

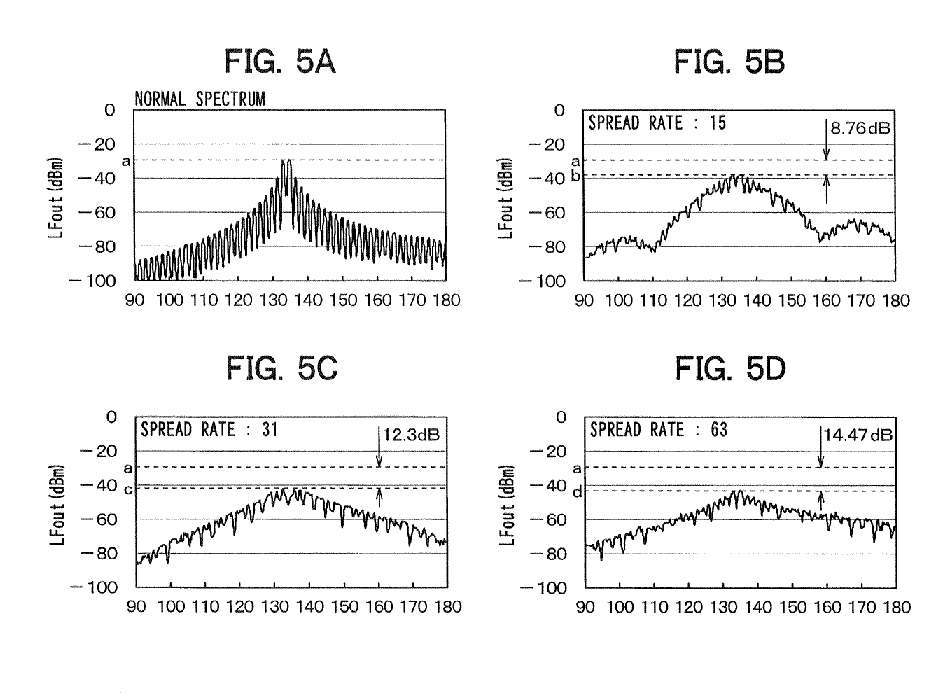

With reference to FIGS. 5A to 5D, the vertical axis represents the electric power level of the signal sent out from the LF transmission antenna 2, and the horizontal axis represents the frequency of kHz scale. If the LF data skips/bypasses the process in the spread process unit 31 and the band pass filter 32, the LF data will be primary-modulated in the primary modulation unit 33, will be amplified in the LF driver 35, and will be sent out from the LF transmission antenna 2. FIG. 5A depicts the frequency spectrum of such signal that has bypassed the spread modulation, where the frequency spectrum has a normal spectrum with the peak level provided at dotted line “a”.

In contrast, the results of the spread-modulation in the spread modulation unit 31 for the same data as the data used in FIG. 5A are shown in FIGS. 5B, 5C, and 5D, respectively using the spread code 3a with the spread rate of 15, 31, and 63. In these cases, the peak level of the output electric power is decreased by 8.76 dB, 12.3 dB, and 14.47 dB, respectively. The peak level of FIGS. 5B, 5C, 5D is provided at the dotted line “b”; “c”, “d”, respectively, where dotted line “a” is provided as the peak level of the normal spectrum of FIG. 5A.

As shown in FIGS. 5B to 5D, the spread-modulated signal has the lowered peak level of the output electric power. Therefore, the signal amplification rate is increased than when the signal that is not spread-modulated, thereby expanding the coverage of the request signal from the in-vehicle system 10 to the portable device 20, with the radio wave intensity kept within an intended range, and without losing the noise tolerance.

According to the Japanese Wireless Radio Wave Law, when the field intensity is “equal to or under 15 μV/m (≈23.5 dBμV/m) at a distance of λ/2π from a line,” such radio wave is usable without permission. The radio wave, as described in the present embodiment, having the peak in the LF wave band (134 kHz band) has a wavelength λ of 2238 m, the maximum field intensity of 15 μV/m (≈23.5 dBμV/m) is measured at a distance of λ/2π, which is 356.49 m. This intensity is converted to a value, which is a measurement at a 3 meter position from the LF transmission antenna 2, of about 105 dBμV/m. Therefore, the field intensity of the request signal is usually designed to have a value equal to or smaller than 105 dBμV/m at a 3 meter position from the LF transmission antenna 2. That is, the in-vehicle system 10 is designed to have such field intensity.

The in-vehicle system 10 of the present embodiment is thus, for example, designed to have the peak field intensity of 105 dBμV/m or a slightly smaller than 105, at a 3 meter position from the LF transmission antenna 2.

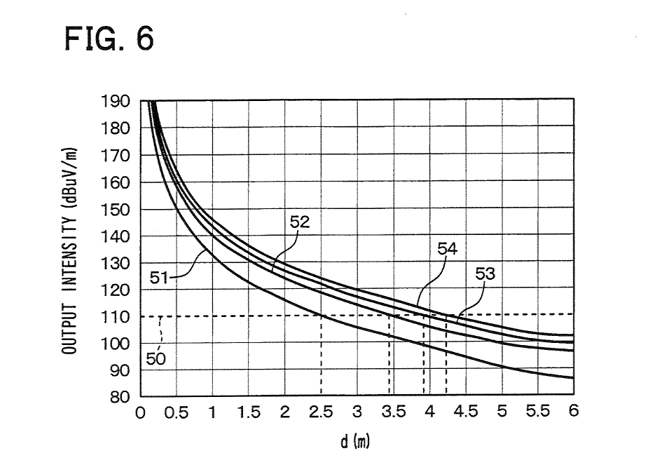

With reference to FIG. 6, the peak level of the request signal at each of various positions takes a value on a line 51, where the line 51 is the intensity of a signal that has not gone through spread spectrum method. In FIG. 6, the horizontal axis represents a distance d from the LF transmission antenna 2 (unit: meter), and the vertical axis represents an intensity (unit: dBμV/m). In addition dotted line 50 represents the threshold when the portable terminal 20 has a sensitivity of 110 dBuV/m.

However, the request signal is reverse spread by the reverse spread process unit 22f, which is in the LF receiver 22 of the portable device 20, and, as a result, the signal having been spread into a wide frequency range is compressed or astringed, thereby being received in a substantially intensified state than the actual intensity represented by line 51 in FIG. 6. That is, in other words, if the predetermined LF data is directly input to the primary modulation unit 33, by skipping the spread process unit 31 and the band pass filter 32, or, if the data is spread and compressed without using a spread spectrum method by the spread rate of 15, 31, and 36 at the spread modulation and the reverse spread demodulation, the request signal at a 3 meter position from the LF transmission antenna 2 should have the intensity of 105 dBμV/m as shown by the lines 52, 53, and 54 in FIG. 6. Lines 52, 53 and 54 represent the output signal intensities, which respectively take into consideration the spread spectrum peak level adjustments translated back to the non-spread spectrumed signal intensity.

When the minimum value of the receivable request signal in the LF wave band by the portable device 20 is 110 dBuV/m, the signal intensity receivable in an area (i.e. in the coverage) of 2.5 meters from the LF transmission antenna 2 without the spread spectrum method may have an increased receivable area by the spread spectrum method having the spread rate of 15, 31, and 63, which are respectively increased to positions of about 3.4 meters, 3.9 meters, and 4.2 meters from the LF transmission antenna 2. That is, without violating the regulation of the Radio Wave Law, the communicable range is expanded.

When the spread rate is greater than 63, the lower end of the frequency band of the request signal substantially reaches 0 Hz. Therefore, the spread rate should be kept equal to or under 63, for achieving high effectiveness of the spread modulation.

The amplification rate setting in the course of manufacturing many in-vehicle systems 10 as the wireless communication system is now described. In the present embodiment, one product (i.e., an in-vehicle system 10) uses a single, i.e., a fixed, spread rate in the spread process unit 31 and a single amplification rate of the amplification in the LF driver 35. However, during the manufacturing of the in-vehicle systems 10, the spread rate of the spread process unit 31 may be different from product to product. More practically, the spread rate may be changed according to the position of LF transmission antenna 2. Further, the amplification rate of the LF driver 35 is increased in proportion to the spread rate of the spread process unit 31 in the same product. The reason for having such configuration is that, as the spread rate increases, the peak level of the center frequency decreases. That is, in other words, the width/range of the signal amplification without violating the Radio Wave Law is increased according to the increase of the spread rate.

When the LF transmitter 3 is installed in an in-vehicle system, the amplification rate of the LF driver 35 is set according to the spread rate of the spread process unit 31. In such manner, by setting the amplification rate according to the spread rate, the communicable range may be properly expanded according to the spread rate.

### Other Embodiments

Although the present disclosure has been fully described in connection with the preferred embodiment thereof with reference to the accompanying drawings, it is to be noted that various changes and modifications will become apparent to those skilled in the art.

For instance, the following modifications may be permissible.

In an in-vehicle system in the above embodiment, the spread rate of the spread process unit 31 and the amplification rate of the LF driver 35 are fixed. However, for example, the spread rate of the spread process unit 31 may be variably changed according to the user operation. In such a case, the amplification rate of the LF driver 35 may also be automatically changed in proportion to the spread rate. More practically, the spread process unit 31 may input a current spread rate used by itself to the LF driver 35 (which is determined by the spread code being used), the LF driver 35 may be configured (i.e., may have a circuit configuration) to increase the amplification rate according to the increase of the inputted spread rate.

Further, the configuration of the above embodiment that the LF data is spread-modulated in the LF transmitter 3 that is separately disposed from the smart ECU 1 may be changed, and the control unit 13 of the smart ECU may realize the function of the spread process unit 31.

Further, the reason for not increasing the radio wave intensity of the request signal that is transmitted from the in-vehicle system may be different from the one described above (i.e., due to the condition/regulation in the Radio Wave Law). That is, the reason for not increasing the radio wave intensity of the request signal may be due to the restriction on the size of a coil antenna for transmitting the request signal.

Such changes and modifications are to be understood as being within the scope of the present disclosure as defined by the appended claims.

What is claimed is:

1. A wireless communication system having an in-vehicle system installed in a vehicle and a portable device carried by a user, the in-vehicle system and the portable device are communicably coupled, the wireless communication system comprising:
a transmission unit disposed in the in-vehicle system for transmitting, to the portable device, a request signal by using a low frequency (LF) wave band, the request signal received by the portable device, wherein the portable device transmits a response signal to the in-vehicle system; and
a smart operation unit disposed in the in-vehicle system for operating an actuator in the vehicle based on the response signal from the portable device, wherein
the transmission unit includes:
a spread process unit for spread-modulating predetermined LF data by using a spread spectrum method to generate a spread data signal; and
a modulation driver unit for converting and amplifying the spread data signal to a modulation signal in the LF wave band and for transmitting the modulation signal to an antenna as the request signal.

2. The wireless communication system of claim 1, wherein
the antenna has a maximum signal intensity output of less than 105 dBuV/m, and,
the antenna has a maximum signal intensity output of greater than 105 dBuV/m, when the predetermined LF data bypasses the spread process unit and is directly inputted to the modulation driver unit.

3. The wireless communication system of claim 1, wherein the modulation driver unit increases an amplification rate of an amplification according to an increase of the spread rate of the spread process unit.

4. A method for manufacturing an in-vehicle apparatus of a wireless communication system, the wireless communication system having the in-vehicle apparatus disposed in a vehicle and a portable device carried by a user, the in-vehicle apparatus and the portable device are communicably coupled, the in-vehicle apparatus transmits a request signal to the portable device and the portable device transmits a response signal to the in-vehicle apparatus after receiving the request signal, the method for manufacturing comprising:
installing a transmission unit in the in-vehicle apparatus to transmit a request signal in an low frequency (LF) wave band, the transmission unit includes: a spread process unit to spread-modulate predetermined LF data by a spread rate to generate a spread data signal; and a modulation driver unit to modulate the spread data signal to a modulation signal in an LF wave band, to amplify the modulation signal by an amplification rate, and to transmit the modulation signal as the request signal;
installing a smart operation unit in the in-vehicle apparatus to operate an actuator in the vehicle based on the response signal; and
setting the amplification rate of the modulation driver unit according to the spread rate of the spread process unit.
